(19) United States
(12) Patent Application Publication
(10) Pub. No.: US 2025/0338172 A1
(43) Pub. Date: Oct. 30, 2025

(54) METHODS, ARCHITECTURES, APPARATUSES AND SYSTEMS FOR NETWORK CODING

(71) Applicant: InterDigital Patent Holdings, Inc., Wilmington, DE (US)

(72) Inventors: Chia-Hung WEI, Chesterbrook, PA (US); Martino FREDA, Laval (CA); Pascal ADJAKPLE, Great Neck, NY (US); Ghyslain PELLETIER, Montréal (CA); Benoit PELLETIER, Roxboro (CA)

(21) Appl. No.: 18/647,277

(22) Filed: Apr. 26, 2024

(51) Int. Cl. H04W 28/06; H04L 1/00; H04L 1/08

(52) U.S. Cl. CPC H04W 28/065; H04L 1/0076; H04L 1/08

(57) ABSTRACT

Procedures, methods, apparatuses, systems, and computer program products for network coding are described. A transmitter WTRU obtains a set of data units, each data unit being a service data unit, SDU, or a SDU segment, performs network coding, NC, encoding on the set of data units to obtain a set of packet data units, PDUs, assigns an order sequence number, SN, to each PDU, the order SN depending on a type of the PDU and indicating an order of the PDU among PDUs of the same type in the set of PDUs and being respectively unique to the set of PDUs, assigns a set SN to the set of PDUs, the set SN being common to the set of PDUs, attaches a NC-specific sub-header to each PDU, the sub-header comprising at least one of the order SN and the set SN, and sends the set of PDUs to a receiver.

### BACKGROUND

The present disclosure is generally directed to the fields of communications, software and encoding, including, for example, to methods, architectures, apparatuses, systems directed to network coding.

### SUMMARY

In a first aspect, the present principles are directed to a method at a wireless transmit/receive unit, WTRU, the method comprising obtaining a set of data units, the set comprising at least one data unit, each data unit being a service data unit, SDU, or a SDU segment, performing network coding, NC, encoding on the set of data units to obtain a set of packet data units, PDUs, assigning an order sequence number, SN, to each PDU, the order SN depending on a type of the PDU and indicating an order of the PDU among PDUs of the same type in the set of PDUs and being respectively unique to the set of PDUs, assigning a set SN to the set of PDUs, the set SN being common to the set of PDUs, attaching a NC-specific sub-header to each PDU, the sub-header comprising at least one of the order SN and the set SN, and sending the set of PDUs to a receiver.

In a second aspect, the present principles are directed to a wireless transfer/receive unit, WTRU, comprising at least one processor configured to obtain a set of data units, the set comprising at least one data unit, each data unit being a service data unit, SDU, or a SDU segment, perform network coding, NC, encoding on the set of data units to obtain a set of packet data units, PDUs, assign an order sequence number, SN, to each PDU, the order SN depending on a type of the PDU and indicating an order of the PDU among PDUs of the same type in the set of PDUs and being respectively unique to the set of PDUs, assign a set SN to the set of PDUs, the set SN being common to the set of PDUs, attach a NC-specific sub-header to each PDU, the sub-header comprising at least one of the order SN and the set SN, and send the set of PDUs to a receiver.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates network coding (NC) implemented as a protocol in the Packet Data Convergence Protocol (PDCP) according to the present principles;

FIG. 3 illustrates a NC protocol in a PDCP entity according to the present principles;

FIG. 4 illustrates a method at a transmitting UE configured with NC protocol in PDCP layer to perform NC according to an embodiment of the present principles;

FIG. 5 illustrates an example segmented-SDU based NC according to an embodiment of the present principles;

FIG. 6 illustrates an example cross-SDUs based NC according to an embodiment of the present principles;

FIG. 7 illustrates an overall method in a transmitting UE according to an embodiment of the present principles;

FIG. 8 illustrates an overall method in a receiving UE according to an embodiment of the present principles;

FIG. 9 illustrates a method of determination of retransmission and additional transmission according to an embodiment of the present principles; and

FIG. 10 illustrates a method of coefficient matrix selection according to an embodiment of the present principles.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

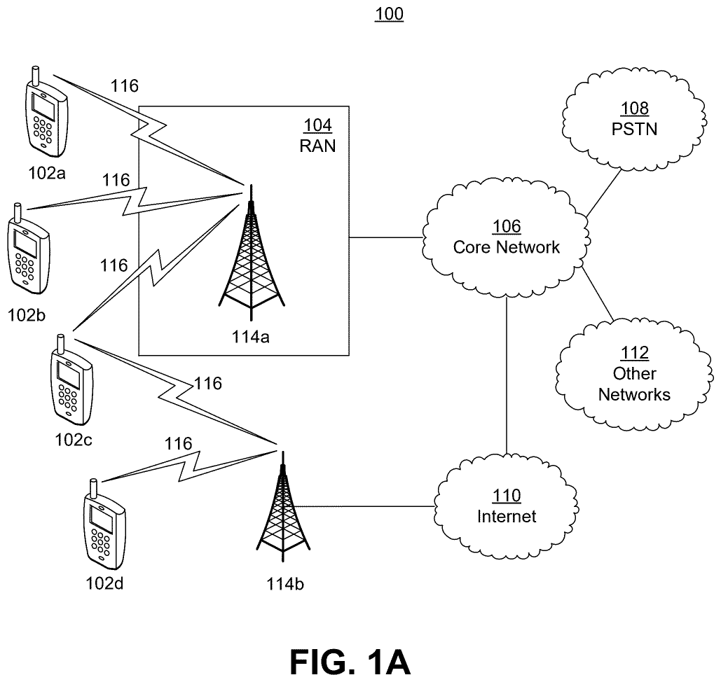

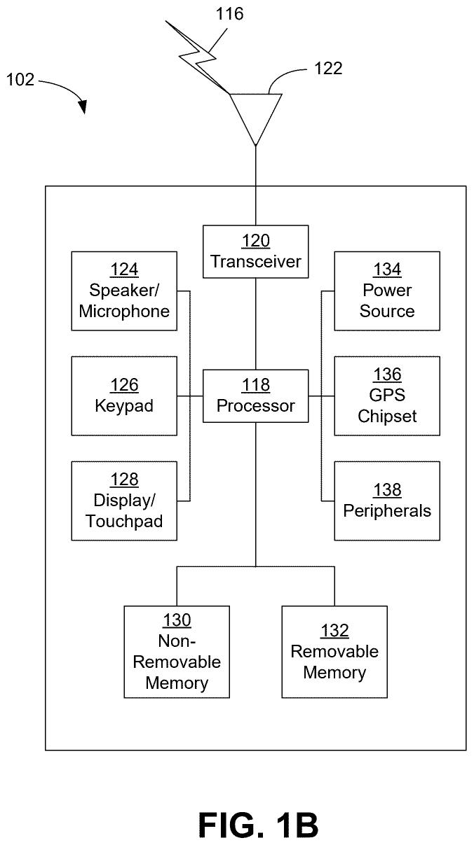

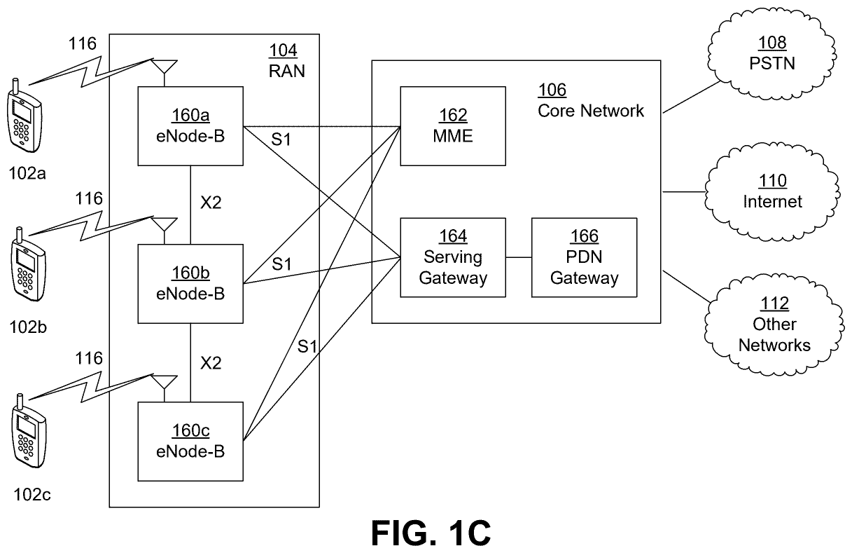

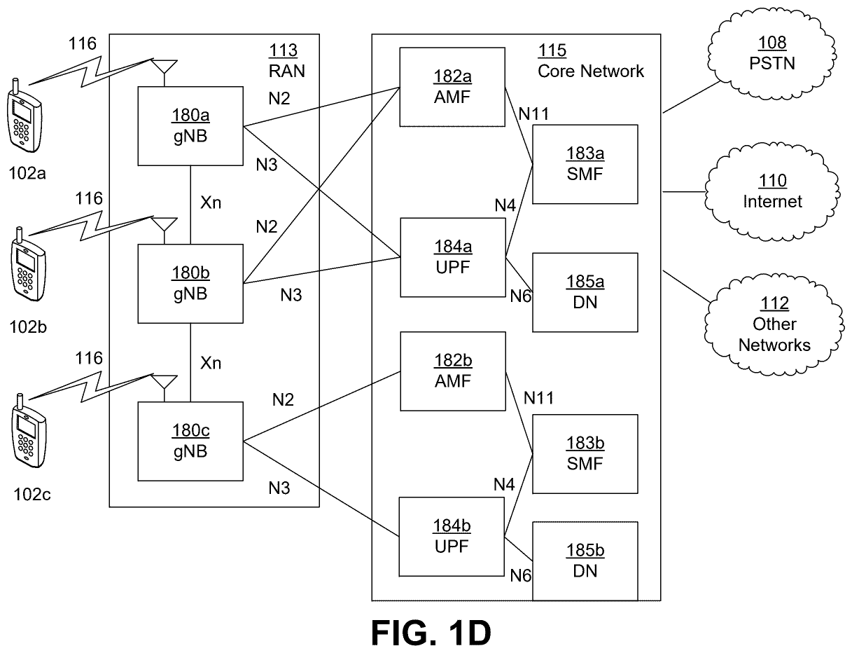

The methods, apparatuses and systems provided herein are well-suited for communications involving both wired and wireless networks. An overview of various types of wireless devices and infrastructure is provided with respect to FIGS. 1A-ID, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

Network Coding (NC) is a packet processing protocol that transform X input packet(s) into Y output packet(s). In general, X (in integer) is greater or equal to 2 and Y (also an integer) is greater or equal to X, with the case X equal to 1 and Y equal to 1 being a special case. The X input packets being coded together form a network coding generation (denoted hereinafter a ‘generation’). An input packet may be a Service Data Unit (SDU) or a segment of a SDU. An output packet is denoted as a Protocol Data Unit (PDU). Network coding can therefore be defined as a packet processing function that transform X SDU(s) into Y PDU(s). The PDUs associated with the same generation may have the same or different characteristics, and therefore be associated with the same or different importance/priority levels. Such characteristics may be systematic packets, coded packets, innovative packets, less-innovative packets, more-innovative packets, SDU size of the, PDU size, erasure correction packet or error correction packet, etc.

“Innovative packet” refers to a NC PDU that is linearly independent from previously transmitted or received NC PDUs within the context of a given NC generation. The term ‘innovative’ in relation with NC PDUs is to be understood as a degree of complexity or differences of the NC PDUs from the previously transmitted or received NC PDUs within the context of a given NC generation. “More-innovative packet” refers to a NC PDU that includes information about a large number of input NC SDUs not used for the generation of the previously transmitted or received NC PDUs within the context of a given NC generation. More-innovative NC PDUs are useful for recovering a large number of NC SDUs at the receiver. “Less-innovative packet” refers to a NC PDU that includes information about a small number of input NC SDUs not used for the generation of the previously transmitted or received NC PDUs within the context of a given NC generation. More-innovative NC PDUs may be useful for recovering of few NC SDUs at the receiver. It is noted that the ‘innovative’ is not to be understood as a measure of obviousness/non-obviousness of aspects of the present principles.

The terms “recovered NC SDU,” “recovered SDU,” “recovered SDU segment,” “recovered NC SDU segment,” and the like may be used herein to mean the same thing, i.e., in reference to a receiver recovering NC SDU(s) or NC SDU segment(s) as a result of successful decoding of received PDUs, where the received PDUs are generated (at the transmitter) based on a NC generation formed by those NC SDU(s) or NC SDU segment(s), i.e., using those NC SDU(s) or SDU segment(s) as input to the NC encoding process.

Furthermore, there may be dependencies between PDUs of the same generation in the sense that: a) the receiver needs to receive X PDUs or more to recover the X SDUs; b) the number of further PDUs or specific PDUs that are needed by the receiver to recover the X SDUs depends on the PDUs already available at the receiver; c) the scheduling of the PDUs of the same generation is constrained by the same overall delay budget.

Possible benefits of network coding include improving reliability under tight latency requirements. Network coding may be applied with or without duplication, or with traditional packet repetition. The use of network coding may alleviate a scheduler from having to select conservative MCS transmission parameters and/or improve the allocation of other transmission resources to improve overall system performance.

Network Coding may operate according to one or more network coding methods. A number of examples of such network coding methods will now be provided.

Fixed rate code: A coding scheme where the coding rate is fixed before transmission. The codeword is either successfully or unsuccessfully decoded at the receiver. No additional redundancy bit is transmitted. Under a fixed code rate scheme, for a given generation of input packets, there is only one iteration (one redundancy version) of network coding, leading to a transmission of a fixed number of coded packets (a fixed size codeword), where the fixed number of coded packets is dictated by the selected fixed code rate.

Rateless codes refer to incremental redundancy codes for encoding data at a variable target packet error rate. With rateless code, the final code rate is not known in advance. Rather, it can only be determined after correctly recovering the transmitted data. In the literature, the rateless code is typically referred to by associated terminologies such as “variable-rate,” “rate-compatible,” “adaptive-rate,” or “incremental redundancy” schemes. However, the rate of a rateless code can be considered in two perspectives, i.e., as the instantaneous rate and the effective rate. The instantaneous rate is the ratio of the number of information bits to the total number of bits transmitted at a specific instant. On the other hand, the effective rate is the rate realized at the specific point when the codeword has been successfully received. Considering a codeword Cᵣ=GᵣP, where Gᵣ is the generator matrix with k columns and r rows and P is at least one input packet, the code rate is k/r. With rateless coding, additional rows can be added to the generator matrix Gᵣ, or equivalently additional coded packets can be added to the codeword Cᵣ, thereby increasing the amount of redundancy and decreasing the code rate. For rateless coding, for a given generation of SDU, the PDUs may be transmitted according to the sequence of redundancy version (example redundancy version, 0, 1, 2, etc.). For each NC iteration or redundancy version, a set of PDUs are transmitted. An initial codeword (initial set of coded packets) targeting an initial code rate is generated in a first iteration (redundancy version) of network coding. This codeword is updated, with additional coded packets generated and transmitted at each subsequent iterations (redundancy version) of network coding until the input packets are successfully recovered by the receiver, or the decoding is eventually declared to have failed (e.g., when, after a predefined maximum number of iterations/redundancy versions, the minimal expected code rate is achieved or surpassed). Herein, the term “code rate” without any qualifier, will be used in reference to the instantaneous code rate, i.e., the code rate at a given iteration of network coding.

Systematic coding is a coding technique where source symbols are part of the output coded symbols, i.e., output from the encoding operation.

Transparent mode is a scheme where network coding is not part of the transmitter or receiver processing.

Coherent network coding is a network coding scheme where one or more of the generator matrices and the topology of the network between the source and destination are assumed known to the destination (i.e. the end-receiver).

Non-coherent network coding is a network coding scheme where none of the one or more of the generator matrices, the topology of the network between the source and destination, is known to the destination (i.e. the end-receiver).

Codebook based network coding is a network work coding scheme where a codebook, or one or more of the codewords is assumed known to the destination (i.e. the end-receiver).

Non-codebook-based network coding is a network work coding scheme where no codebook, or no codeword is assumed known to the destination (i.e. the end-receiver).

Adaptive network coding is a network coding scheme that enables dynamic control, and adaptation of network coding operation over lossy channels by, e.g., configuring and adapting coding parameters (e.g., generation, generation size, and transmission of output/coded packets) to meet the instantaneous delay-throughput-reliability requirements according to the radio condition changes (the channel variation) over time, accounting for the possibly loss of degree of freedom due to erasures (i.e. packet drops) or transmission errors (i.e. bit errors during transmission). Herein, a feedback-based network coding scheme is one form of adaptive network coding where the transmitter adapts network coding operation based on feedback (e.g., successful decoding or failed decoding) from the receiver (peer or remote).

Segmented-SDU based NC is a network coding scheme where a NC SDU are segmented into NC SDU segments, and packet generations include only NC SDU segments. Re-assembly of NC SDU segments is performed at the end destination (decoder) to form the original NC SDU.

Cross-SDUs based NC SDU concatenation-based NC is a network coding scheme where packet generations include only non-segmented SDUs.

Hybrid segmented-SDU based NC or Cross-SDUs based NC is a network coding scheme where a generation comprises of NC SDUs or NC SDU segments. This scheme will be denoted hybrid NC.

In fixed block coding, the encoding and decoding is on a per-block based i.e. on a fixed set of packets (disjoint generation).

In sliding window coding, the coding is performed across a dynamic set of packets i.e. packets to be encoded (e.g. source or native packets) can be added or removed from the sliding window dynamically.

Network coding (NC) may be applied to further improve reliability and/or reduce latency of wireless transmissions in a number of connectivity scenarios and data services. For example, it may improve data transmissions for real-time immersive and multi-sensory communication and services, such as Extended Reality (XR) or Metaverse, as well as providing communication services required for connected industries and automation that may have latency requirements as low as in the sub −10 ms or even sub ms ranges.

The 5G NR design supports Packet Data Convergence Protocol (PDCP) duplications and other plain duplication redundancy techniques in support of ultra-reliable and low latency communication services. Considering increasing requirements in terms of various key performance metrics such as spectral efficiency, latency, reliability, data rate and the need for a concurrent support of these requirements, the use of redundancy via plain duplication as a solution is generally neither efficient nor scalable.

Network coding can provide flexible redundancy coding rate for different reliability requirements and flexible split of transmission of coded packets over different transmission paths (e.g. frequency diversity, spatial diversity, code diversity) or over different time instances (for time domain diversity).

In reference to the existing 5G system, network coding can be used to improve efficiency for the support of multicast broadcast services, sidelink services (e.g. V2X services), enhanced mobile broadband services with the added benefits of better link efficiency, reduced latency, improved reliability, and reduced buffering requirements. Example of deployment scenarios includes CA (Carrier Aggregation), DC (Dual Connectivity), IAB (Integrated access and backhaul), and sidelink, including sidelink relay.

As referred to the protocol stack defined by 3rd Generation Partnership Project (3GPP) for Radio Access Network (RAN) of New Radio (NR) mobile communication system, a sequence numbering function was operated in the PDCP layer [see 3GPP TS 38.323 V18.0.0 Packet Data Convergence Protocol (PDCP) specification] to associate each PDCP SDUs with a Sequence Number (SN). The sequence numbering was introduced to support the operation of multiple SN-related functions for a variety of purposes such as in-sequence delivery, duplicate detection, buffer management, data recovery, data retransmission, ciphering and integrity protection. For example, in-sequence delivery, the receiver may determine the order of the received PDUs by identifying their associated SNs.

For illustrative purposes, the present principles are described using the following example embodiment based on three, non-limitative system assumptions.

First, the system is referred to the protocol stack defined by 3rd Generation Partnership Project (3GPP) for Radio Access Network (RAN) of New Radio (NR) mobile communication system.

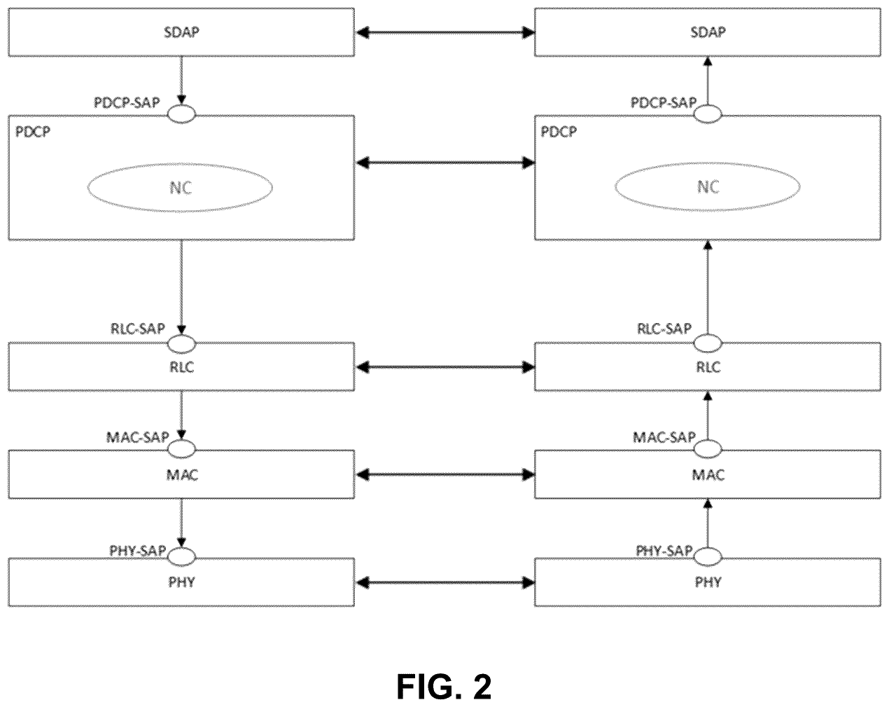

Second, the network coding (NC) is implemented as a protocol in the PDCP layer, as illustrated in FIG. 2.

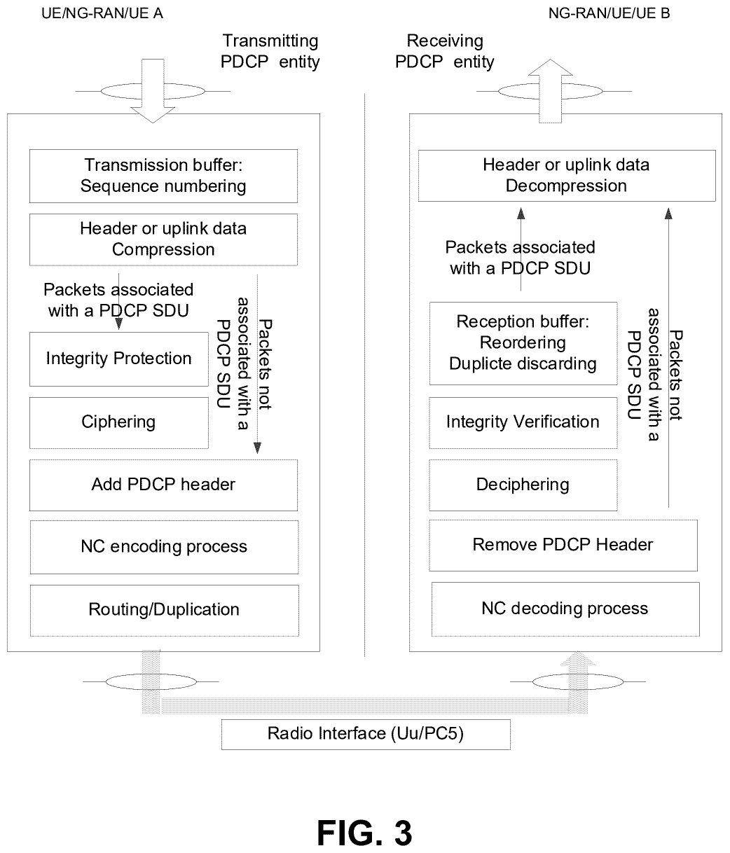

Third, to limit impact on legacy functionalities, the NC protocol is treated as a black box from the PDCP perspective and it is assumed that the NC protocol is performed after PDCP header addition but before routing PDCP PDU(s) to a lower layer as illustrated in FIG. 3. That is, for each PDCP SDU, the PDCP entity generates a PDCP header to be attached to each PDCP SDU before performing the NC encoding process. After the NC encoding process, the PDCP entity routes the output packet (i.e., PDCP PDU) to the lower layer. Herein, the PDCP header is also assumed to be encoded by the NC protocol.

It is noted that the embodiments of the present principles may also be adopted by other system assumptions, for example, the PDCP header is not encoded by the NC protocol and/or the NC protocol placed in different orders within PDCP entity.

Herein, the term “systematic PDU” may be used to denote a PDU carrying systematic packet, and the term “non-systematic PDU” as a PDU carrying non-systematic packet.

The present principles provide a solution to how to perform sequencing in PDCP after introducing the network coding.

It is first noted that network coding is not supported in current 3GPP radio protocols. The current PDCP sequencing (numbering) procedure in 3GPP radio protocols is operated on a basis that there is a one-to-one mapping between PDCP SDUs and PDCP PDUs. Through the PDCP sequencing procedure, each PDCP SDU is associated with a PDCP SN. The PDCP SN is carried by the PDCP PDU that is associated with the PDCP SDU. The PDCP SN is applied by the receiver to determine the order of the received PDCP PDUs.

In PDCP sublayer, there are multiple functions whose operation is based on the PDCP SN. For example, in-order delivery of the PDCP SDUs to the upper layer at the receiver (i.e. in the same order as the SDUs were delivered from the upper layer to the PDCP at the transmitter) is assisted by the sequencing PDCP SDUs at the transmitter. However, in case the NC protocol is implemented in PDCP, the one-to-one mapping relationship between PDCP SDU and PDCP PDU is no longer valid. For example, PDCP SDU(s) may be segmented or concatenated for the NC encoding process. Hence, a PDCP SDU may be associated with multiple PDCP PDUs after the NC encoding. In this situation, it is not clear how the PDCP entity performs sequencing at the transmitter to support the requirement of SN-related functions (e.g., in-order delivery) at the receiver. Specifically, it is not known how the transmitting UE is to perform sequencing to support the receiving UE identifying the order of the received PDCP PDUs and the association between PDU and SDU, what data unit needs to be numbered, how the sequence number (SN) can be kept unique.

Further, in case NC is implemented, to perform the NC decoding process efficiently, the receiver may need one or more items of information that will now be described.

Mapping relationship between PDCP SDU(s) and PDCP PDU(s). For example, the NC decoder needs to determine which PDCP PDUs may be grouped as a set for input to the NC decoding process. Specifically, the receiver needs to identify to which NC generation the received PDCP PDU(s) are associated with.

NC coefficients applied for NC encoding process. During NC encoding, the transmitter may apply one or multiple coefficients as input to perform the NC encoding process. Conversely, the decoder at the receiver side needs such information to establish linear equations for the NC decoding process.

Identification of systematic packet. To reduce NC decoding complexity and increase decoding efficiency, it is typically beneficial to let the receiver understand which PDUs carry systematic packets.

However, it is not clear how the transmitter performs sequencing to assist the receiver to derive the above items of information. Furthermore, it is also not clear to which data unit the transmitter applies the sequence number, where to carry the sequence information (e.g., SN), what is the format of the SN is, how to keep the SN unique, or what the range of the SN is.

To achieve higher efficiency of Network Coding and/or to achieve different QoS requirements on different packets, the transmitter and/or the receiver may perform differentiated handling on PDCP SDUs/PDUs. For example, the PDCP SDUs of different PDU Sets may be coded differently, and the systematic packet may be routed to the lower layer differently than the coded packet. Hence, it is not clear how the sequencing can support differentiated handing.

It is noted that, in the example embodiment, the PDCP header is encoded by the NC protocol, and that the legacy PDCP SN carried in the PDCP header cannot be identified by the receiver before the corresponding PDCP PDU has been successfully NC decoded.

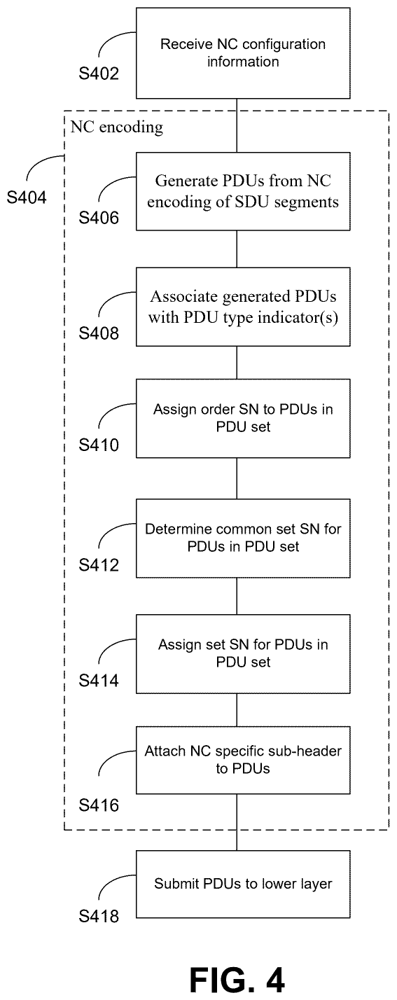

FIG. 4 illustrates a method at a transmitting UE configured with NC protocol in PDCP layer to perform NC according to an embodiment of the present principles. Sequencing PDU is based on the order within NC PDU set and the association with NC PDU set according to the present principles.

Briefly speaking, a transmitting UE assigns an order SN to a PDU based on an order of the PDU within a NC PDU set, and assigns a NC PDU set SN to the PDU based on an association of the PDU with the NC PDU set. The order SN associated with different types of PDUs may take different ranges of values based on a NC configuration received from a gNB.

In step S402, the UE receives NC configuration information from a gNB. The NC configuration information indicates one or more range(s) of order SN, each range being associated with a type of PDU (e.g., systematic packets vs. non-systematic packet, error correction vs. erasure correction). The UE uses the NC configuration information to configure its NC encoding process.

In step S404, the UE performs a NC encoding process for data units, i.e. one or more SDUs or segments of one or more SDUs, by the configured NC protocol. The NC encoding process includes at least one of steps S406-S416.

In step S406, the UE generates a number of PDUs from the NC encoding of the data units, wherein the PDUs can be of different types.

In step S408, the UE can associate a PDU type indicator with each generated PDUs. This may be done using an implicit approach or an explicit approach.

In the implicit approach, the UE assigns different ranges of order SN to different types of PDU, The UE can determine a range of unique order SN values based on the type of the PDU and the NC configuration. For example, a first type of PDU can be assigned to an order SN with a value within a first range indicated by the NC configuration, and a second type of PDU can be assigned to an order SN with a value within a second range indicated by the NC configuration. In another example, a particular range of the value is reserved for the first x PDUs generated using the SDU segments being encoded together, wherein the x may be indicated by the gNB and the x is equal to at least the number of the SDU segments being encoded together.

In the explicit approach, the UE includes a PDU type indicator in a NC header of the PDU. The value of the indicator may refer to a type of PDU predefined by a mapping table configured by the NC configuration. The UE can assign an order SN depending on the type.

In step S410, the UE assigns an order SN with a value within the determined range to each PDU in a NC PDU set generated by the NC. The order SN can, as mentioned, be determined depending on the PDU type, but it can for example also be a sequential number.

In step S412, the UE determines, based on the PDCP SN, a common value of a NC PDU set SN for the all the PDUs in the NC PDU set. In one example, the NC PDU set SN may be equal to the PDCP SN of the SDU applied to generate the PDU. In another example, the NC PDU set SN may be set to a subset of the PDCP SN of the SDU applied to generate the PDU, for example the y Least Significant Bits (LSB), wherein the y is indicated by the NC configuration. In cross-SDUs NC (that will be described later), the NC PDU set SN may be set to a PDCP SN of a SDU within a SDU set, where the SDU has the smallest/largest value of the PDCP SN.

In step S414, the UE assigns a NC PDU set SN with the value within the determined range (i.e. the value determined in step S412) to each PDU in a NC PDU set generated by the NC.

In step S416, the UE attaches a NC specific sub-header to the each of the PDUs. The NC specific sub-header carries the order SN and/or NC PDU set SN.

In step S418, the UE submits (sends, transfers) the PDUs to the lower layer.

As can be seen, a transmitting UE is configured with a NC protocol in the PDCP layer. The NC protocol may perform a NC encoding process including transforming X input packet(s) into Y output packet(s). Herein, the X input packet(s) are denoted as a NC generation. The NC protocol supports multiple NC generations to be NC encoded individually in parallel. That is, each NC generation can be NC encoded independently based on individual input packets (i.e., SDUs).

The NC encoding process can have two different approaches: Segmented-SDU based and Cross-SDUs based that will now be described.

Segmented-SDU based NC may be described as including four stages at the transmitting UE.

Stage 1 includes receiving one or more SDU(s) from the upper layer, and performing none, one or more pre-process(es) for the one or more SDU(s). The pre-processes may be, but are not limited to, legacy procedures in the PDCP layer.

Stage 2 includes segmenting each of the one or more SDU(s) into multiple SDU segments. It is noted that, herein, the term “SDU segment” may be interpreted as “segmented SDU” and/or “segment of SDU”.

Stage 3 includes applying coding coefficients associated with each SDU segment. The coding coefficients are selected based on the order of each SDU segment within the original SDU.

Stage 4 includes generating one or more PDU(s), performing none, one or more post-process(es) for the one or more PDU(s), wherein the post-processes may be, but are not limited to, legacy procedures in PDCP layer, and delivering the one or more PDU(s) to the lower layer.

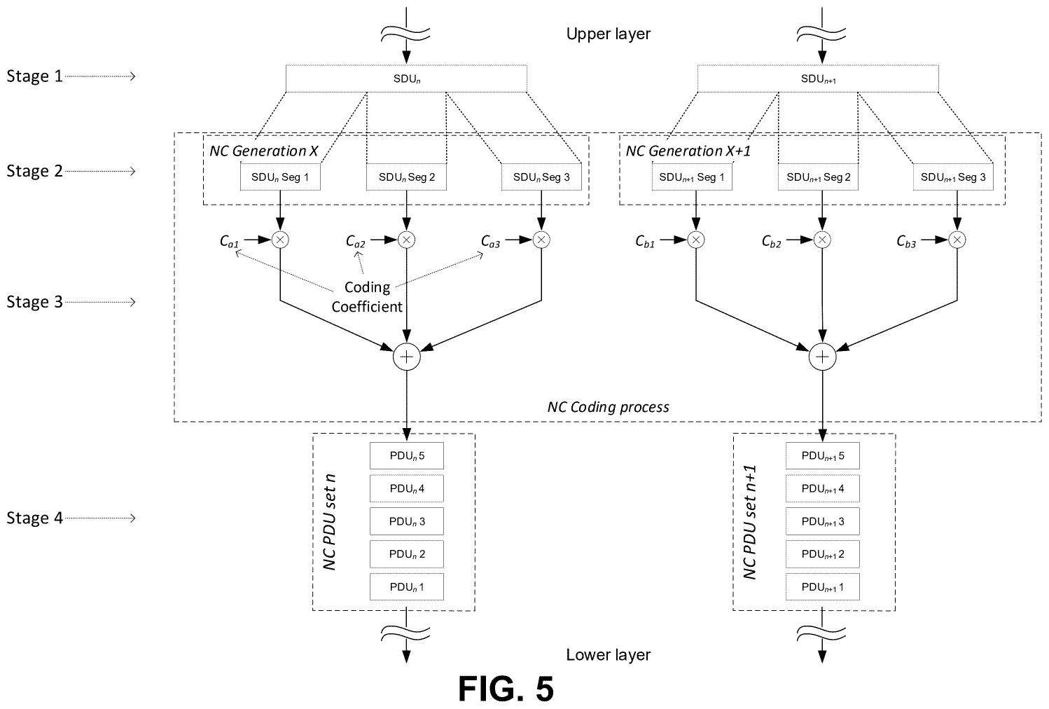

FIG. 5 illustrates an example segmented-SDU based NC according to an embodiment of the present principles. FIG. 5 illustrates the stages already described.

The following explains the notation in FIG. 5.

SDUₙ: The input packet n of NC encoding process.

SDUₙ Seg X: The X-th segment of SDUₙ.

PDUₙ X: The X-th output packet of the NC encoding process by using SDUₙ.

Cₐ₁: The first coding coefficient of coefficient vector a. A coefficient vector is assumed to have one or more coding coefficients.

NC PDU set n: A set of coded packets encoded by using SDUₙ.

As illustrated shown in FIG. 5, the transmitting UE receives SDUₙ and SDUₙ₊₁ from the upper layer sequentially. The SDUₙ and SDUₙ₊₁ are processed via individual NC processes, respectively. That is, the SDUₙ is segmented into multiple segments (i.e., SDUₙ Seg 1, SDUₙ Seg 2, and SDUₙ Seg 3). SDUₙ Seg 1, SDUₙ Seg 2, and SDUₙ Seg 3 are denoted as NC generation X that is encoded by applying coding coefficients, which generates multiple coded packets (i.e., PDUₙ 1, PDUₙ 2, PDUₙ 3, PDUₙ 4 and PDUₙ 5). The coded packets associated with the same NC generation are denoted as belonging to same NC PDU set. That is, PDUₙ 1, PDUₙ 2, PDUₙ 3, PDUₙ 4 and PDUₙ 5 belong to NC PDU set n. Alternatively, it can be stated that NC PDU set n contains the PDUₙ 1, PDUₙ 2, PDUₙ 3, PDUₙ 4 and PDUₙ 5. The Coding coefficients Cₐ₁, Cₐ₂ and Cₐ₃ are represented as three coding coefficients applied to encode SDUₙ Seg 1, SDUₙ Seg 2, and SDUₙ Seg 3.

Each coding vector may contain multiple coding coefficients, and each of PDUₙ 1, PDUₙ 2, PDUₙ 3, PDUₙ 4 and PDUₙ 5 are generated by applying coding coefficients of different coefficient vectors. Similarly, SDUₙ₊₁ is segmented into multiple segments (i.e., SDUₙ₊₁ Seg 1, SDUₙ₊₁ Seg 2, and SDUₙ₊₁ Seg 3). SDUₙ₊₁ Seg 1, SDUₙ₊₁ Seg 2, and SDUₙ₊₁ Seg 3 are denoted as NC generation Y that is encoded by applying coding coefficients, which generates multiple coded packets (i.e., PDUₙ₊₁ 1, PDU₊₁ 2, PDUₙ₊₁ 3, PDUₙ₊₁ 4 and PDUₙ₊₁ 5). PDUₙ₊₁ 1, PDUₙ₊₁ 2, PDUₙ₊₁ 3, PDUₙ₊₁ 4 and PDUₙ₊₁ 5 belong to NC PDU set n+1. Alternatively, it can be stated that NC PDU set n+1 contains PDUₙ₊₁ 1, PDUₙ₊₁ 2, PDUₙ₊₁ 3, PDUₙ₊₁ 4 and PDUₙ₊₁ 5. The Coding coefficient C_{b1}, C_{b2} and C_{b3} are represented as three coding coefficients applied to encode SDUₙ₊₁ Seg 1, SDUₙ₊₁ Seg 2, and SDUₙ₊₁ Seg 3. Each coefficient vector may contain multiple coefficient coefficients, and each of PDUₙ₊₁ 1, PDUₙ₊₁ 2, PDUₙ₊₁ 3, PDUₙ₊₁ 4 and PDUₙ₊₁ 5 may be generated by applying coding coefficients within different coding vectors.

Cross-SDUs based NC may be described as including three stages at the transmitting UE.

Stage 1 includes receiving one or more SDU(s) from the upper layer, performing none, one or more pre-process(es) for the one or more SDU(s) that may include but are not limited to legacy procedures in the PDCP layer, and grouping multiple SDUs as a NC SDU set (NC generation) for NC encoding process.

Stage 2 includes applying the coding coefficients associated with each of SDUs of the NC SDU set.

Stage 3 includes generating one or more PDU(s), performing none, one or more post-process(es) for the one or more PDU(s) that may include but are not limited to legacy procedures in the PDCP layer, and delivering the one or more PDU(s) to the lower layer.

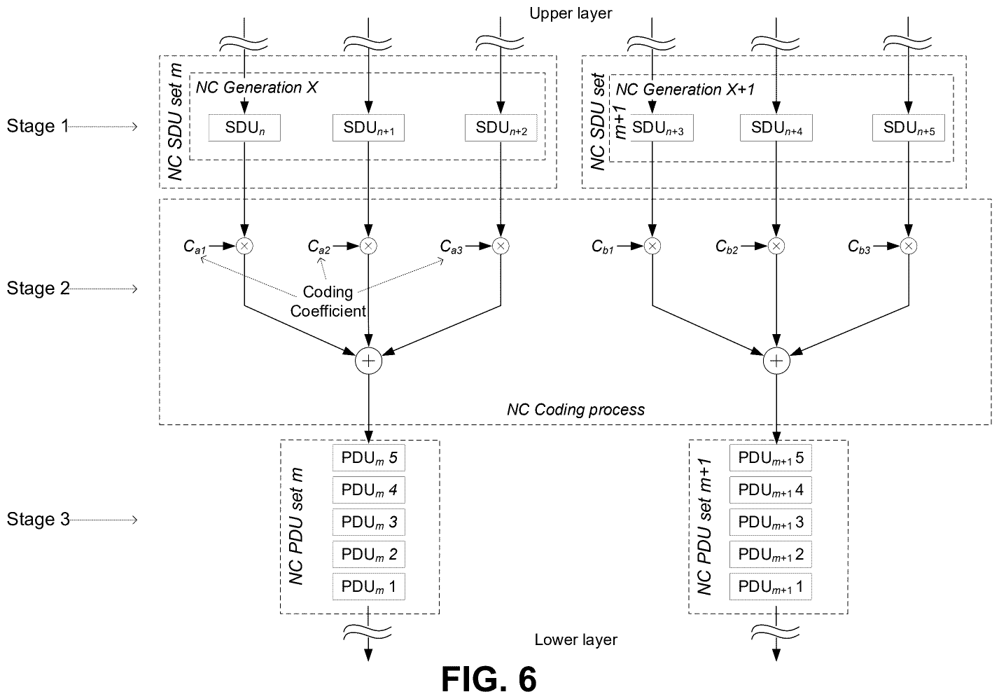

FIG. 6 illustrates an example cross-SDUs based NC according to an embodiment of the present principles. FIG. 6 illustrates the stages already described.

The following explains the notation in FIG. 6.

SDUₙ: Input packet n to the NC encoding process.

NC SDU Set m: Input packet Set m to a NC encoding process. The SDU Set m may be denoted as a NC generation.

PDUₘ X: The X-th output packet of the NC encoding process by using NC SDU set m.

Cₐ₁: The first coding coefficient of coefficient vector a. A coefficient vector is assumed to have one or more coding coefficient(s).

NC PDU set m: A set of coded packets encoding by using NC SDU Set m.

As shown in FIG. 6, the transmitting UE receives SDUₙ, SDUₙ₊₁, SDUₙ₊₂, SDUₙ₊₃, SDUₙ₊₄, and SDUₙ₊₅ from the upper layer sequentially. SDUₙ, SDUₙ₊₁ and SDUₙ₊₂ are grouped as NC SDU set m. SDUₙ₊₃, SDUₙ₊₄, and SDUₙ₊₅ are grouped as NC SDU set m+1. NC SDU set m and NC SDU set m+1 are denoted as NC generation X and NC generation Y respectively. The SDUₙ, SDUₙ₊₁ and SDUₙ₊₂ are encoded by applying coding coefficients and then generates multiple coded packets (i.e., PDUₘ 1, PDUₘ 2, PDUₘ 3, PDUₘ 4 and PDUₘ 5). The coded packets associated with same NC generation are denoted as belonging to same NC PDU set. That is, PDUₘ 1, PDUₘ 2, PDUₘ 3, PDUₘ 4 and PDUₘ 5 belong to NC PDU set m. Alternatively, it can be interpreted as the NC PDU set m contains PDUₘ 1, PDUₘ 2, PDUₘ 3, PDUₘ 4 and PDUₘ 5. Coding coefficients Cₐ₁, Cₐ₂ and Cₐ₃ are represented as three coding coefficients applied to encode SDUₙ, SDUₙ₊₁ and SDUₙ₊₂. Each coding vector may contain multiple coefficient coefficients, and each of PDUₘ 1, PDUₘ 2, PDUₘ 3, PDUₘ 4 and PDUₘ 5 may be generated by applying coding coefficients of different coefficient vectors. Similarly, SDUₙ₊₃, SDUₙ₊₄, and SDUₙ₊₅ are encoded by applying coding coefficients, which generates multiple coded packets (i.e., PDUₘ₊₁ 1, PDUₘ₊₁ 2, PDUₘ₊₁ 3, PDUₘ₊₁ 4 and PDUₘ₊₁ 5). PDUₘ₊₁ 1, PDUₘ₊₁ 2, PDUₘ₊₁ 3, PDUₘ₊₁ 4 and PDUₘ₊₁ 5 belong to NC PDU set m+1. Alternatively, it can be interpreted as NC PDU set m+1 contains PDUₘ₊₁ 1, PDUₘ₊₁ 2, PDUₘ₊₁ 3, PDUₘ₊₁ 4 and PDUₘ₊₁ 5. Coding coefficients C_{b1}, C_{b2} and C_{b3} are represented as three coding coefficients applied to encode SDUₙ₊₃, SDUₙ₊₄, and SDUₙ₊₅. Each coding vector may contain multiple coding coefficients, and each of PDUₘ₊₁ 1, PDUₘ₊₁ 2, PDUₘ₊₁ 3, PDUₘ₊₁ 4 and PDUₘ₊₁ 5 may be generated by applying coding coefficients of different coefficient vectors.

It is noted that, the SDUs and PDUs herein may be interpreted as the input packet of the NC protocol and the output packet of the NC protocol, respectively. That is, the SDUs may be pre-processed by legacy procedure(s) in PDCP layer before input to the NC protocol. And the PDUs may be post-processed by legacy procedure(s) in PDCP layer after output from the NC protocol.

Further, herein a “coefficient matrix” is a matrix carrying a set of coding coefficients. Each coefficient matrix may contain one or multiple rows and one or multiple columns.

Further yet, herein a “coefficient vector” is a set of coding coefficients which may be referred to either a row of a coefficient matrix or a column of a coefficient matrix.

As already mentioned, a transmitting UE and/or receiving UE may receive NC configuration information that the UE may use for configuration to support NC protocol operation.

A transmitting and/or a receiving UE may receive the NC configuration information from the gNB. The NC configuration information may, but is not limited to, be carried by a downlink RRC message.

The NC configuration information may contain at least one or more of the following items of information:

a parameter range_order_SN_type indicating a value range that can be used for an order SN to be assigned to a specific type of PDU;

a parameter range_NC_PDU_set_SN_type indicating a value range that can be used for an NC PDU set SN to be assigned to a specific type of PDU;

a parameter sub_PDCP_SN indicating a specific number of right most bits (i.e., LSB) of PDCP SN for NC PDU set SN (for example, this parameter can indicate the bit-width of the NC PDU set SN is set to the specific number (e.g., x bits), and the value of the NC PDU set SN is set to the LSB x bits (i.e., x right most bits) of PDCP SN);

a PDU type mapping table (for example, a mapping table that indicates a mapping relationship between a number of indices and a number of PDU types, where each index is mapped to a PDU type);

a parameter maximum_encoding_NC_segments indicating a maximum number of NC segments that can be NC encoded together;

a parameter maximum_SDU_segment_size indicating a maximum size of a SDU that can be segmented from a SDU;

a parameter maximum_SDU_segments indicating a maximum number of SDU segments that can be segmented from a SDU;

a parameter maximum_number_SDU indicating a maximum number of SDUs that may be grouped as a NC SDU set;

one or more of coefficient matrix(es), where each coefficient matrix may contain one or multiple rows and one or multiple columns, each row may be represented as a coefficient vector in the present disclosure, and each coefficient vector contains one or multiple of coding coefficients (for example, in one implementation, each coefficient matrix may be associated with a coefficient matrix index and each coefficient vector may be associated with a coefficient vector index); and

a parameter additional_PDU indicating a specific amount of PDUs the transmitting UE needs to generate by using same NC generation.

The NC configuration may be, but is not limited to, a radio bearer/a PDCP specific configuration. That is, for different PDCP entities/radio bearers configured with a respective NC protocol, the gNB may provide individual NC configurations for each of the configured NC protocols.

It is noted that the mentioned NC configuration is not limited to being configured by RRC only. In other words, the NC configuration may be configured through Downlink Control Indicator (DCI), MAC Control Element (CE), layer 1 and/or layer 2 signal.

In some other embodiments, the NC configuration corresponds to a standardised NC configuration.

According to the present principles, PDU sequencing can be based on the order within a NC PDU set, as will now be described.

A transmitting UE can assign an order SN to a PDU based on a type of the PDU and on an order of the PDU within a NC PDU set.

After a NC encoding process is performed at transmitting UE by using a NC generation, the NC encoding process may generate a set of PDU (i.e., a NC PDU set). The NC PDU set contains one or more PDUs. Each PDU within (i.e., belonging to) the NC PDU set may be assigned an order SN by the transmitting UE. The value of the order SN may be determined based on one or more of the order of the PDU within the NC PDU set, the types of the PDU (e.g., systematic packets vs. non-systematic packet, error correction vs. erasure correction), and the (index of) coefficient vector applied to generate the PDU.

In some embodiments, the values of the order SN for each PDU within a NC PDU set may be assigned in increasing or decreasing order.

In some embodiments, different types of PDU may be assigned with order SN individually. Within a NC PDU set, the values of the order SN for each of PDUs belonging to the same type may be assigned in increasing or decreasing order.

In some embodiments, the earlier generated PDU may be assigned with an order SN having a smaller (larger) value. In other words, the later generated PDU may be assigned with an order SN having a larger (smaller) value.

In some embodiments, the PDU generated by applying coefficient vector having a smaller (larger) row (column) index may be assigned with order SN having a smaller (larger) value.

Based on the value of the order SN of a received PDU, the receiving UE may identify the order of the received PDU within a NC PDU set.

A transmitting UE may associate a PDU type indicator with each PDU. This may be done using an implicit approach or an explicit approach.

In the implicit approach, a type of PDU is indicated by the value of order SN assigned to the PDU. That is, in the receiver side, the type of PDU may be identified by the value of the order SN of the corresponding PDU.

In some embodiments, the order SN assigned to different types of PDU may take different ranges of values. For example, a first type of PDU is assigned with an order SN with a value within a first range, and a second type of PDU is assigned with an order SN with a value within a second range. The first range and the second range are indicated by the NC configurations. It is noted that, a range of value of an order SN may either be pre-defined or pre-configured by the gNB via downlink RRC signalling.

In some embodiments, the order SN assigned to different types of PDU may take different ranges of values based on a NC configuration received from a gNB. That is, the NC configuration indicates to the UE the range of the value of order SN that may be assigned to a particular type of PDU. The NC configuration may indicate more than one range.

Specifically, the order SN assigned to different types of PDU may take different ranges of values by the transmitting UE. That is, while the transmitting UE assigns order SN to each PDU of the NC PDU set, the transmitting UE may take values from different ranges according to the type of PDU. A value range for a type of PDU may be preconfigured. The value range for a type of PDU may, but is not limited to, be pre-configured by gNB via RRC message (i.e., range_order_SN_type).

In some embodiments, the transmitting UE may be configured with a range_order_SN_type that a value range that can be used for an order SN to be assigned to a specific type of PDU.

In some embodiments, the transmitting UE may be configured with multiple of range_order_SN_type, each range_order_SN_type indicating a value range can be used for an order SN to be assigned to a specific type of PDU. For example, the transmitting UE is configured with a first range_order_SN for a first type of PDU and a second range_order_SN for a second type of PDU. While assigning order SN to PDUs, an order SN to be assigned to a first type of PDU may take a value from a first range indicated by a first range_order_SN_type, an order SN to be assigned to a second type of PDU may take a value from a second range indicated by a second range_order_SN_type, and so on.

Table 1 illustrates an example in which a UE is configured with four range_order_SN_type (i.e., first range_order_SN_type, second range_order_SN_type, third range_order_SN_type and fourth range_order_SN_type), each is for a type of PDU. In the example, the first range_order_SN_type is for systematic packets, the second range_order_SN_type is for non-systematic packets, the third range_order_SN_type is for error correction packets and the fourth range_order_SN_type is for erasure correction packets.

TABLE 1
Example of configuration of value ranges for order SN

| | range of order SN for the type of PDU |
|---|---|
| Type of PDU | (indicated by range_order_SN_type) |
| systematic packet | 1 to W |
| non-systematic packet | W + 1 to X |
| error correction packet | X + 1 to Y |
| erasure correction packet | Y + 1 to Z |

While assigning order SN to PDUs, a systematic packet may be assigned a value from 1 to W, a non-systematic packet may be assigned a value from W+1 to X, an error correction packet may be assigned a value from X+1 to Y, and an erasure correction packet may be assigned a value from Y+1 to Z, wherein W, X, Y and Z may be, but are not limited to, positive integers.

In some embodiments, a range of value of an order SN may be determined (by the UE) based on at least one of UE capabilities, a size of a coefficient matrix applied for generating the PDU, a number of rows/columns of a coefficient matrix applied for generating the PDU, a maximum size of a codeword, a maximum number of PDUs may be generated by using a NC generation, a maximum number of NC processes supported by the UE in parallel, a maximum number of NC processes supported by the UE for a PDCP entity, a maximum number of NC processes supported by the UE for a radio bearer, a maximum number of NC processes configured by the gNB, a total number of NC processes configured by the gNB for a PDCP entity, and a total number of NC processes configured by the gNB for a radio bearer.

Based on a value of an order SN carried by a received PDU, the receiving UE may identify the type of the received PDU. Specifically, the receiving UE may identify the type of the received PDU according to a range of the value and one or more RRC configuration messages received from the gNB, wherein the RRC configuration messages indicate the mapping between the ranges and the PDU types.

In the explicit approach, a type of PDU is identified by a PDU type indicator assigned to the PDU. A transmitting UE may include a PDU type indicator in a NC header of a PDU wherein the PDU type indicator indicates the type of PDU the PDU. In some embodiments, a value of the PDU type indicator may be mapped to a type of PDU, where the mapping relationship may either be predefined by a mapping table configured by the NC configuration (i.e., PDU type mapping table), or be predefined in a standard (and thus, for example, already configured in the UE).

The value of the order SN may, but is not limited to, be unique in one of the following two example levels.

NC PDU set level. The transmitting UE entity may assign order SN with different values to different PDUs of a NC PDU set. In other words, the transmitting UE may assign order SN with the same value to PDUs belonging to different NC PDU sets.

Radio bearer level. The transmitting UE may assign order SN with different values to different PDUs associated with same radio bearer. In other words, the transmitting UE may assign order SN with the same value to PDUs belonging to different radio bearer.

The order SN may be carried in the payload of the PDU or be carried by a specific header attached to the PDU. The specific header may be introduced to carry the order SN. That is, each PDU may respectively have the specific header.

In some embodiments, the order SN is implicitly identified by coding coefficients.

In downlink transmission, gNB applies a coefficient matrix to generate one or more PDU(s). Specifically, the gNB applies different coefficient vectors within the coefficient matrix to generate the PDU(s), that is, each PDUs may be generated by applying a coefficient vector within the coefficient matrix, wherein a coefficient vector includes multiple coding coefficients. Which coefficient vector to apply to generate the PDU may follow a pre-defined order (rule). For example, a first PDU can be generated by applying coding coefficients of a first coefficient vector, a second PDU can be generated by applying coding coefficients of a second coefficient vector, and so on. In this case, the UE may identify an order of a PDU based on the coding coefficient applied to generate the PDU, wherein the coding coefficient applied to generate the PDU may be indicated by the transmitting device (gNB) to the receiving device (UE) that hence may identify the order of the PDU without order SN.

In some embodiments, the receiving UE identifies the order of a received PDU based on the coding coefficients and/or coefficient vector carried by the PDU. For example, after having generated the PDU(s), the transmitting UE may include coding coefficient related information into each PDU(s). The coding coefficient related information may for example be one or multiple coding coefficient(s) applied to generate the one or multiple PDU(s), one or multiple coefficient vector(s) applied to generate the one or multiple PDU(s), or one or multiple coefficient matrix(es) applied to generate the one or multiple PDU(s).

It is noted that it herein is assumed that a coefficient matrix contains one or multiple coefficient vectors, and that each coefficient vector contains one or multiple coding coefficients.

In some embodiments, the receiving UE is pre-configured with the coefficient matrix(es). After receiving a PDU, the receiving UE identifies, based on the coding coefficient related information carried by the PDU, which coding coefficient(s) and/or coefficient vector was applied by the transmitting UE to generate the PDU. The receiving UE can determine the order of the PDU based on the identified coding coefficient(s) and/or coefficient vector.

According to the present principles, PDU sequencing can be based the association with NC PDU set and SDU (or SDU set).

A transmitting UE can assign a NC PDU set SN to each PDU based on an association of the PDU with a NC PDU set.

The transmitting UE may generate a set of PDUs (i.e., a NC PDU set). The NC PDU set contains one or multiple of PDUs of which each may be assigned a NC PDU set SN. The value of the NC PDU set SN assigned to a PDU can be determined based on an association with a NC PDU set to which the PDU belongs. For example, the value of the NC PDU set SN can be set to the value of the NC PDU set identifier.

In some embodiments, the values of the NC PDU set SN for each PDU within a NC PDU set may be assigned a common value that for example may be set to one of, in segmented-SDU based NC, a PDCP SN of the SDU used to generate the PDU, and, in cross-SDUs based NC, a (subset of) smallest value of PDCP SN of PDUs within the NC PDU set, and a (subset of) largest value of PDCP SN of PDUs within the NC PDU set. The subset may be represented as a number Least Significant Bits (LSB), and it may be determined/configured by the NC configuration (i.e., sub_PDCP_SN).

Based on the value of the NC PDU set SN of a received PDU, the receiving UE may identify to which NC PDU set the received PDU belongs, wherein the identification may be performed during or before the NC decoding process.

A NC PDU set SN can be assigned based on the type of PDU and the association with NC PDU set.

The NC PDU set SN assigned to different types of PDU may take different ranges of values by the transmitting UE. That is, while the transmitting UE assigns NC PDU set SN to each PDU of the NC PDU set, it may take values from different ranges according to the type of PDU. A value range for a type of PDU may be preconfigured. The value range for a type of PDU may for example be pre-configured by gNB via RRC message (i.e., range_NC_PDU_set_SN_type).

In some embodiments, the transmitting UE may be configured with a range_NC_PDU_set_SN_type indicating a value range that can be used for an NC PDU set SN to be assigned to a specific type of PDU.

In some embodiments, similar to the example illustrated in Table 1), the transmitting UE may be configured with multiple range_NC_PDU_set_SN_type, each indicating a value range that can be used for an NC PDU set SN to be assigned to a specific type of PDU. For example, the transmitting UE can be configured with a first range_NC_PDU_set_SN_type for a first type of PDU and a second range_NC_PDU_set_SN_type for a second type of PDU. While assigning NC PDU set SN to PDUs, a NC PDU set SN to be assigned to a first type of PDU may take value from a first range indicated by a first range_NC_PDU_set_SN_type, a NC PDU set SN to be assigned to a second type of PDU may take value from a second range indicated by a second range_NC_PDU_set_SN_type, and so on.

The value of the NC PDU set SN may for example be unique on the radio bearer level so that PDUs associated with same radio bearer but belonging to different NC PDU sets may be assigned different values of NC PDU set SN. In other words, the transmitting UE may assign the same value of NC PDU set SN to PDUs belonging to different radio bearers.

The NC PDU set SN may be carried in the payload of the PDU or by a specific header attached to the PDU. The specific header may for example be introduced to carry the NC PDU set SN. That is, the specific header may be attached to each PDU respectively.

According to the present principles, SDU and SDU segments can be sequenced.

A transmitting UE can assign a segment SN and a SDU SN to each SDU segment of a SDU based on an order (or position) of the SDU segment within the SDU (identified by the SDU SN) and the association with the SDU.

In case of segmented-SDU based NC, the transmitting UE may segment each received SDU into multiple SDU segments that can be used to generate one or more of PDU(s).

To at least assist the receiving UE identify the order of each SDU segment for SDU assembly, the transmitting UE may perform sequencing on the SDU segments. The sequencing may include assigning segment SN to each SDU segment, and assigning a SDU SN to each SDU segment.

The sequencing may performed in different manners.

The value of the segment SN may be determined based on the position of the SDU segment within the SDU. The value of the segment SN may be determined based on order of the SDU segment within the SDU. A maximum value of the segment SN may be determined based on a NC configuration received from gNB, wherein the NC configuration is carried by RRC message. For example,

The NC configuration (i.e., maximum_encoding_NC_segments) may indicate a maximum number of NC segments that may be NC encoded together, or the NC configuration (i.e., maximum_SDU_segment_size) may indicate a maximum size of a SDU segment, a maximum value of the segment SN may be determined based on a UE capability reported to the gNB, wherein the UE capability includes a maximum of number of SDU segments that may be NC encoded together, and the value of the SDU SN that may be set to legacy PDCP SN of the SDU.

Based on the value of the segment SN of a SDU segment, the receiving UE may identify the order/position of the SDU segment within an SDU.

Based on the values of segment SN of each SDU segment, the receiving UE may reassembly the SDU segments into SDU. The reassembly procedure may for example include receiving multiple SDU segments, and each with a segment SN and a SDU SN, performing a reassembly process for the multiple SDU segments (wherein the reassembly process can include at least one of identifying a value of a segment SN and a value of a SDU SN of each SDU segments, determining a SDU to which the SDU segments belong based on value of the SDU SN, and identifying an order/position of each of the multiple SDU segments within the SDU based on the values of the segment SN of the each SDU segment), and reassembling the multiple SDU segments into the SDU based on at least the value of the segment SN and the value of the SDU SN.

A transmitting UE can assign a NC SDU set SN to each SDU of a NC SDU set based on an order of the SDU within the NC SDU set (identified by the NC SDU set SN).

In case of cross-SDUs based NC, the transmitting UE may group multiple received SDUs into a NC SDU set. The transmitting UE may then generate one or more PDU(s) by using the multiple SDUs within the NC SDU set. The number of SDUs grouped as a NC SDU set may be indicated by the NC configuration (i.e., maximum_number_SDU).

To at least assist the receiving UE identify which SDUs are grouped by the transmitting for NC encoding, the transmitting UE may perform sequencing on the multiple SDUs within the NC SDU set. The sequencing may include assigning a NC SDU set SN to each SDU.

The sequencing can further include the value of the NC SDU set SN for each SDU that may be set to a specific PDCP SN. The specific PDCP SN may for example be a (subset of) smallest PDCP SN among SDUs within the NC SDU set, or a (subset of) largest PDCP SN among SDUs within the NC SDU set.

The subset may be represented as a number Least Significant Bits (LSB) and be configured by the NC configuration (i.e., sub_PDCP_SN).

The value of the segment SN may for example be unique on the NC SDU set level or the radio bearer level.

On the NC SDU set level, the transmitting UE entity may assign segment SN with different values to different SDU segments of a NC SDU set. In other words, the transmitting UE may assign segment SN with the same value to SDU segments belonging to different NC SDU sets.

On the radio bearer level, the transmitting UE may assign segment SN with different values to different SDU segments associated with same radio bearer. In other words, the transmitting UE may assign segment SN with the same value to SDU segments belonging to different radio bearer.

The segment SN may be carried in the payload of the SDU or by a specific header attached to the SDU segment. The specific header may for example be introduced to carry the segment SN. That is, the specific header may be attached to each SDU segment respectively.

The transmitting UE can determine to retransmit PDU(s) or generate additional PDU(s) to transmit based on PDCP feedback received from a receiving UE.

The transmitting UE may receive PDCP feedback from a receiving UE. The PDCP feedback may carry reception status of SDU(s) transmitted by the transmitting UE. The SDU reception status carried by the PDCP feedback may be indicated by the segment SN and/or the SDU SN.

In Segmented-SDU based NC, the SDU reception status may be indicated by at least two indicators carried by the PDCP feedback: a first indicator indicating a SDU SN, and a second indicator indicating respectively whether the SDU segments belonging to the SDU indicated by the first indicator are missing or received successfully. The second indicator may be implemented as a bitmap having at least a number of bits equal to the maximum number of SDU segments (indicated by maximum_SDU_segments) that can be segmented from an SDU. Each bit of the bitmap indicates the reception status of a corresponding SDU segment belonging to an SDU. For example, a bit associated with a SDU segment set to a particular value represents that the SDU segment is either missing (if set to a first value) or received successfully (if set to a second value).

The transmitting UE may further determine to perform PDU retransmission or additional PDU transmission based on the PDCP feedback. In one embodiment, in case the PDCP feedback indicates a missing SDU, the transmitting UE can generate additional PDU(s) by using the SDU segment(s), and perform an additional transmission for the additional generated PDU(s). In another embodiment, in case the PDCP feedback indicates a missing SDU segment, the transmitting UE can retransmit specific PDU(s) associated with the missing SDU segment.

In Cross-SDUs based NC, the SDU reception status may be indicated by at least two indicators carried by the PDCP feedback: a first indicator indicating a NC PDU set SN, and a second indicator indicating respectively whether the SDU(s) within the NC SDU set indicated by the first indicator are missing or received successfully; The second indicator may be implemented as a bitmap having at least a number of bits equal to the maximum number of SDU (indicated by the maximum_number_SDU) that may be grouped for NC encoding. Each bit of the bitmap indicates the reception status of a corresponding SDU within the NC SDU set. For example, a bit associated with a SDU set to a particular value represents that the SDU is missing (if set to a first value) or received successfully (if set to a second value).

The transmitting UE may further determine to perform PDU retransmission or additional PDU transmission based on the PDCP feedback. In one embodiment, in case the PDCP feedback indicates a missing NC SDU set, the transmitting UE generates additional PDU(s) by using the SDU(s) within the NC SDU set and performs an additional transmission for the additional generated PDU(s). In another embodiment, in case the PDCP feedback indicates a missing SDU, the transmitting UE retransmits specific PDU(s) associated with the missing SDU. A receiving UE can reassemble the recovered SDU segments into a SDU based on the order/position of the received SDU segments within a SDU, wherein the order/position is identified based on the segment SN and the SDU SN of the received SDU segments.

A method for a receiving UE configured with NC protocol in PDCP layer to perform NC operation can include one or more of

receiving multiple of PDUs from the lower layer, performing NC decoding for the received multiple PDUs and generating multiple SDU segments, and reassembling the SDU segments into a SDU based on the value of segment SN of each SDU segment, wherein the segment SN is carried by a sub-header of the SDU segment, and the order of the each SDU segment within a SDU, which may be the same as the order of values of each SDU segment.

According to the present principles, the transmitting UE can determine retransmission or additional transmission.

As for PDCP feedback based on the order SN and/or NC PDU set SN, a transmitting UE can receive PDCP feedback from a receiving UE, the PDCP feedback indicating PDU reception status.

As such, while the NC protocol is activated, the transmitting UE may receive one or more PDCP feedback from a receiving UE. The PDCP feedback may carry the reception status of PDU(s) transmitted by the transmitting UE. The PDU reception status carried by the PDCP feedback may be indicated by the order SN and/or the NC PDU set SN.

In one embodiment, the PDU reception status may be indicated by at least two indicators carried by the PDCP feedback a first indicator indicating a NC PDU set SN, and a second indicator respectively indicating the PDUs within the NC PDU set indicated by the first indicator that are missing or received successfully; The second indicator may be implemented as a bitmap having at least a number of bits equal to the maximum number of PDU may be generated by using a NC generation. Each bit of the bitmap indicates the reception status of a corresponding PDU in the NC PDU set. For example, a bit associated with a PDU set to a particular value represents whether the PDU is missing (if set to a first value) or received successfully (if set to a second value).

In another embodiment, the PDCP reception status is indicated by at least two indicators carried by the PDCP feedback a first indicator indicating a NC PDU set SN of a first missing PDU, and a second indicator indicating the NC PDU set that has not been decoded successfully (if any) and the NC PDU set that has been decoded successfully (if any). The second indicator may be a bitmap having at least a number of bits equal to the maximum number of NC process associated with a radio bearer. The position of each bit of the bitmap is implicitly associated with a NC PDU set, and the value of a bit indicates whether or not the associated NC PDU set is decoded successfully.

For example, the first bit of the bitmap refers to a NC PDU set having a NC PDU set SN equal to x+1, wherein a NC PDU set is indicated by the first indicator having a NC PDU set SN equal to x. The second bit of the bitmap refers to a NC PDU set having a NC PDU set SN equal to x+2, wherein a NC PDU set is indicated by the first indicator having a NC PDU set SN equal to x, and so on.

In some embodiments, the PDCP reception status is indicated by at the following indicators carried by the PDCP feedback one or more indicator(s) indicating NC PDU set SN(s) of one or more NC PDU set, where each indicator is associated with a NC PDU set and indicates whether or not the corresponding NC PDU set has been decoded successfully.

It is noted that, instead of introducing a NC specific PDCP feedback mechanism as mentioned to indicate the receiving status of a PDU and/or a NC PDU set, the receiving UE can reuse the legacy PDCP status report mechanism to indicate the corresponding receiving status.

When it comes to retransmission or additional transmission, a transmitting UE can determine to perform PDU retransmission or to generate additional PDU(s) for further transmission based on the order SN and/or the NC PDU set SN carried by a PDCP feedback received from a receiving UE.

While the NC protocol is activated, the transmitting UE may receive PDCP feedback from a receiving UE. The PDCP feedback may carry the reception status of PDU(s) transmitted by the transmitting UE. The PDU reception status carried by the PDCP feedback may be indicated by the order SN and/or the NC PDU set SN. Based on at least the PDCP feedback, the transmitting UE may determine to perform either PDU retransmission or additional PDU transmission. The additional PDU may be generated by the transmitting UE using same NC generation. In some embodiments, the additional PDU is generated by the transmitting UE using the same NC generation but applying different coding coefficients, different coefficient vectors and/or different coefficient matrices.

There are different embodiments for how a transmitting UE determines to perform either PDU retransmission or additional PDU transmission, as will be described. These embodiments can be combined in various ways.

The transmitting UE determines to perform a PDU retransmission in response to reception of PDCP feedback that indicates an order SN of the PDU.

The transmitting UE determines to perform a PDU retransmission in response to reception of PDCP feedback that indicates both an order SN of the PDU and a NC PDU set SN of a NC PDU set to which the PDU belongs.

The transmitting UE determines to perform additional PDU transmission in response to reception of PDCP feedback that indicates a NC PDU set SN.

The transmitting UE determines to perform additional PDU transmission in response to reception of PDCP feedback that indicates at least an order SN having a value within a particular range.

The transmitting UE determines to perform PDU retransmission in response to reception of PDCP feedback that indicates at least an order SN having a value within a particular range.

The transmitting UE determines to perform additional PDU transmission in response to reception of PDCP feedback that indicates at least an NC PDU set SN having a value within a particular range; and/or

The transmitting UE determines to perform PDU retransmission in response to reception of PDCP feedback that indicates at least an NC PDU set SN having a value within a particular range.

As already mentioned, the transmitting UE can generate additional PDU(s), as will now be further described.

In case the transmitting UE, in response to PDCP feedback, determines to perform additional PDU transmission, the transmitting UE may generate the additional PDU(s) in different ways, of which examples will now be described.

The transmitting UE may generate one or more additional PDU(s) by using the NC generation.

The transmitting UE may generate one or more additional PDU(s) by using the NC generation and applying the coefficient matrix. The additional PDU(s) may be generated by applying different coefficient vector(s) within the coefficient matrix.

The transmitting UE may generate one or more additional PDU(s) by using the NC generation and applying a different coefficient matrix.

The transmitting UE may generate one or more additional PDU(s) by using the NC generation and applying different coding coefficient(s).

The transmitting UE may generate one or more additional PDU(s) by using the NC generation and applying different rows of coding coefficient(s).

In some embodiments, the transmitting UE may generate a specific amount of additional PDU(s), wherein the specific amount is preconfigured by a NC configuration (i.e., additional_PDU) received from the gNB.

According to the present principles, there are different embodiments for coding coefficient selection and assignment.

In a first embodiment, the transmitting UE selects and assigns a coding coefficient to the SDU (segment) based on QoS/radio bearer characteristic, segment SN and/or the SDU SN, as will be further described.

The transmitting UE may be configured with one or more coefficient matrices from a gNB via the NC configuration, wherein each coefficient matrix includes multiple rows, and each row includes multiple coding coefficients.

The selection and assignation of the coding coefficients may be made differently depending on whether segmented-SDU based NC or cross-SDUs based NC is used.

In Segmented-SDU based NC, the transmitting UE may be configured with a coefficient matrix from a gNB, wherein the coefficient matrix includes multiple rows, and each row includes multiple coding coefficients. For each SDU segment, the transmitting UE selects and applies a coding coefficient from a row of the coefficient matrix based on one or more criteria. The criteria may for example be a value of segment SN of the corresponding SDU, a value of SDU SN of the corresponding SDU, and/or QoS/bearer characteristics associated with the SDU segment.

In an embodiment, the UE selects a coding coefficient within a row of a coefficient matrix and applies it to a SDU segment according to the segment SN, wherein the order of the selected coefficient is the same as the order of the SDU segment within the SDU. The order may be either an ascending order or a descending order. For example, for a first SDU segment the UE may select a first coding coefficient in a coefficient vector, and for a second SDU segment the UE may select second coding coefficient in the coefficient vector, and so on.

In another embodiment, the UE selects a subset of a coefficient matrix based on the value of the SDU SN. Then, the UE selects a coding coefficient within a row of the subset of coefficient matrix and applies it to a SDU segment according to the segment SN, wherein the order of the selected coefficient is the same as the order of the SDU segment within the SDU. The order may be either an ascending order or a descending order.

In another embodiment, the UE is configured with multiple coefficient matrices. The UE determines a coefficient matrix among the multiple coefficient matrices based on the SDU SN. Then, the UE selects a coding coefficient within a row of a coefficient matrix and applies it to a SDU segment according to the segment SN, wherein the order of the selected coefficient is the same as the order of the SDU segment within the SDU. The order may be either an ascending order or a descending order.

In another embodiment, the UE is configured with multiple coefficient matrices. UE determines a coefficient matrix among the multiple coefficient matrices based on the QoS/bearer characteristics associated with the SDU segment. Then, the UE selects a coding coefficient within a row of a coefficient matrix and applies it to a SDU segment according to the segment SN, wherein the order of the selected coefficient is the same as the order of the SDU segment within the SDU. The order may be either an ascending order or a descending order. It is noted that, a SDU segment of a SDU with higher reliability requirements may be associated with a more robust coefficient matrix.

In Cross-SDUs based NC, the transmitting UE may be configured with a coefficient matrix from a gNB, wherein the coefficient matrix includes multiple rows, and each row includes multiple coding coefficients. For each SDU the transmitting UE selects and applies a coding coefficient from a row of the coefficient matrix based on one or more criteria. The criteria may for example be a value of SDU SN of the corresponding SDU, and/or QoS/bearer characteristics associated with the SDU.

In one embodiment, the UE selects a coding coefficient within a row of a coefficient matrix and applies it to a SDU according to the SDU SN, wherein the order of the selected coefficient is the same as the order of the SDU within the NC SDU set. The order may be either an ascending order or a descending order. For example, for the first SDU the UE may select a first coding coefficient in a coefficient vector, and for the second SDU the UE may select a second coding coefficient in the coefficient vector, and so on.

In another embodiment, the UE selects a subset of coefficient matrix from a coefficient matrix based on the value of the SDU SN. Then, the UE selects a coding coefficient within a row of the subset of coefficient matrix and applies it to a SDU according to the SDU SN, wherein the order of the selected coefficient is the same as the order of the SDU within the NC SDU set. The order may be either an ascending order or a descending order.

In another embodiment, the UE is configured with multiple coefficient matrices. The UE determines a coefficient matrix among the multiple coefficient matrices based on the SDU SN. Then, the UE selects a coding coefficient within a row of a coefficient matrix and applies it to a SDU according to the SDU SN, wherein the order of the selected coefficient is the same as the order of the SDU within the NC SDU set. The order may be either an ascending order or a descending order.

In another embodiment, the UE is configured with multiple coefficient matrices. The UE determines a coefficient matrix among the multiple coefficient matrices based on the QoS/bearer characteristics associated with the SDU. Then, the UE selects a coding coefficient within a row of a coefficient matrix and applies it to a SDU according to the SDU SN, wherein the order of the selected coefficient is the same as the order of the SDU within the NC SDU set. The order may be either an ascending order or a descending order. It is noted that, a SDU of a NC SDU set with higher reliability requirements may be associated with a more robust coefficient matrix.

It is noted that the QoS characteristics may for example include packet dropping rate, packet error rate, a robustness requirement, a reliability requirement, a delay requirement, and a jitter requirement.

In a second embodiment, the transmitting UE selects and assigns different coding coefficient to the SDU (segment) for generating additional PDU for additional transmission.

In case the transmitting UE needs to generate additional PDU for additional transmission—for example, in response to receive PDCP feedback indicating a missing PDU and/or unsuccessful decoding of a NC PDU set and/or unsuccessful decoding of a SDU—the transmitting UE may generate additional PDU for additional transmission. For generating the additional PDU(s), the transmitting UE may select coding coefficient(s) (or coefficient vector(s)) different from the coding coefficient applied to generate the PDU for initial transmission.

In one embodiment, the transmitting UE may a select coding coefficient from a coefficient matrix different from the coefficient matrix applied to generate the PDU for initial transmission.

In another embodiment, the transmission UE may select coding coefficient(s) (or coefficient vector(s)) from a second coefficient matrix that is different from a first coefficient matrix applied to generate the PDU for initial transmission. Both the first and the second coefficient matrices are preconfigured by a NC configuration received from the gNB through the NC configuration (i.e., one or more of coefficient matrix(es)). The NC configuration may further indicate to the transmitting UE the coefficient matrix(es) to be applied to generate PDU for initial transmission or additional transmission respectively.

In another embodiment, the transmitting UE may select coding coefficient(s) (or coefficient vector(s)) from a coefficient matrix that is the same as the coefficient matrix applied to generate the PDU for initial transmission.

In another embodiment, the transmission UE may select coding coefficient(s) (or coefficient vector(s)) from a coefficient matrix that is the same as the coefficient matrix applied to generate the PDU for initial transmission, but from a different range of rows. The different range of rows may be a range of rows pre-indicated/specific for generating the additional PDU(s). The range may for example be preconfigured by a NC configuration received from the gNB through RRC messaging. That is, the NC configuration may indicate to the transmitting UE the ranges of rows of a coefficient matrix to be applied to generate PDU for initial transmission or additional transmission, respectively.

In a third embodiment, the transmitting UE selects and assigns different coding coefficient to the SDU (segment) for generating additional PDU for additional transmission. The range of the rows of the coefficient matrix or the coefficient matrix that should be applied by the transmitting UE for generating additional PDU(s) may be explicitly indicated by the receiver. For example, a coefficient matrix index may be carried by a PDCP feedback received from the receiver, or a specific row range indicator may be carried by the PDCP feedback. The coefficient matrix index may also refer to one of coefficient matrices preconfigured by the gNB, and the row range indicator may refer to a range of rows of a coefficient matrix.

In a fourth embodiment, the transmitting UE includes the coding coefficient in a PDU.

At the UE, the NC encoding process may generate a set of PDU (i.e., a NC PDU set) including one or more PDUs.

In downlink transmission, gNB applies a coefficient matrix to generate one or more PDU(s). Specifically, the gNB applies different coefficient vectors within the coefficient matrix to generate the one or more PDU(s). That is, each of the PDUs may be generated by applying a coefficient vector within the coefficient matrix, wherein a coefficient vector includes multiple coding coefficients. The gNB may indicate the coding coefficients applied to generate a PDU to the UE. That is, the coding coefficient applied to generate the PDU may be indicated by the transmitting device (gNB) to the receiving device (UE). It is noted that the coding coefficients may be indicated by a coding coefficient indicator (i.e., coefficient matrix index) carried by the PDU, a coefficient vector indicator (i.e., coefficient vector index) carried by the PDU, or coding coefficient(s) carried by the PDU.

The coding coefficient indicator may be an indicator indicating one or more coefficient vectors of a coefficient matrix.

In an embodiment, the coding coefficients are placed in the PDU in same order as the corresponding values of segment SN of each SDU segments. The receiving UE may identify the order of the SDU segments according to the coding coefficients and the order of the coding coefficients.

In an embodiment, the transmitting UE including a coding coefficient index associated with a row of the coding coefficient matrix into a PDU generated using the SDU segments.

The PDU(s) can be routed to the lower layer in different ways.

In a first embodiment, the UE performs differentiated handling in PDCP and/or lower layer(s), submits the PDU to a specific associated RLC based on the value of the order SN and/or the NC PDU set SN.

As already described, the transmitting UE may generate a set of PDU (a NC PDU set) including one or more PDU(s). Each PDU within the NC PDU set may be assigned with an order SN and/or a NC PDU set SN by the transmitting UE. After assigning the order SN and/or the NC PDU set SN, the transmitting UE may submit the PDU (with order SN and/or the NC PDU set SN attached) to the lower layer. That is, the generated PDUs may be submitted by a PDCP entity of the transmitting UE to lower layers, wherein the lower layers for example may be interpreted as associated RLC and/or MAC layer(s).

In addition, the transmitting UE may perform differentiated handing for the PDU(s). The differentiated handling may for example be that the transmitting UE applies different routing methods when submitting the one or multiple PDU(s) to lower layer(s).

In one embodiment, the differentiated handling includes performing, by the transmitting UE, different routing methods for PDUs with different value of NC PDU set SN.

For example, in case of a PDU associated NC PDU set SN having a value within a first range, the transmitting UE submits the PDU to a first (set of) associated RLC entity(ies). And in case of the PDU associated NC PDU set SN having a value within a second range, the transmitting UE submits the PDU to a second (set of) RLC entity(ies). The first and second (sets of) RLC entities may for example be pre-indicated by gNB via downlink RRC signaling. Similarly, the first and the second range are pre-indicated by gNB via downlink RRC signaling (e.g., range_NC_PDU_set_SN_type).

In another embodiment, the transmitting UE performs different routing methods for PDUs with different value of order SN.

For example, in case of a PDU associated order SN having a value within a first range, the transmitting UE submits the PDU to a first (set of) associated RLC entity(ies). And in case of the PDU associated order SN having a value within a second range, the transmitting UE submits the PDU to a second (set of) RLC entity(ies). The first and second (sets of) RLC entities may for example be pre-indicated by gNB via downlink RRC signaling. Similarly, the first and the second range are pre-indicated by gNB via downlink RRC signaling (e.g., range_order_SN_type).

In a second embodiment, the UE submits the NC PDU set SN to the lower layers to assist lower layer to perform differentiate handling. To assist the lower layer(s) perform differentiated handling on the PDUs, the PDCP layer of the transmitting UE may submit the order SN and/or the NC PDU set SN to the lower layers that may perform different logical channel prioritization (LCP) configurations for PDU with different order SN and/or different NC PDU set SN.

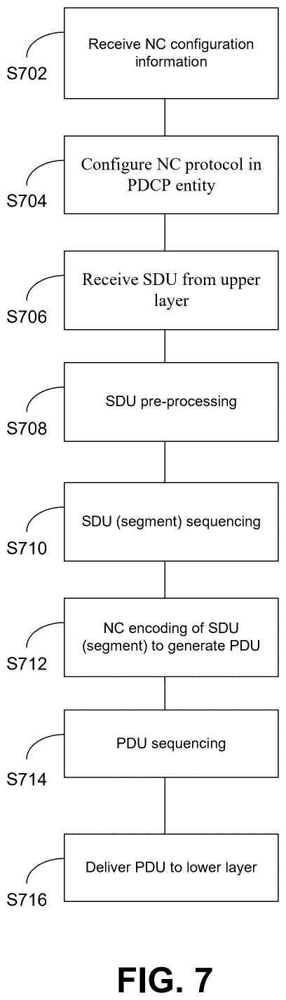

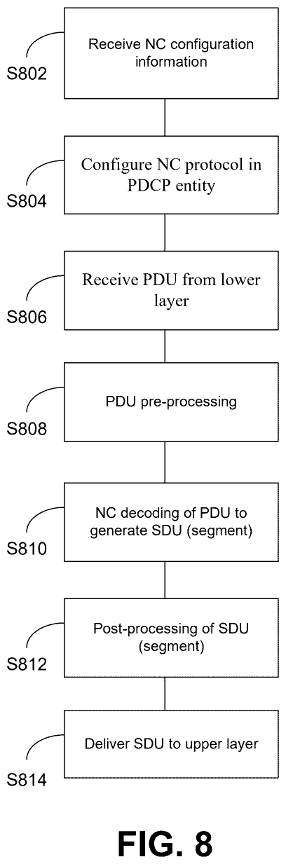

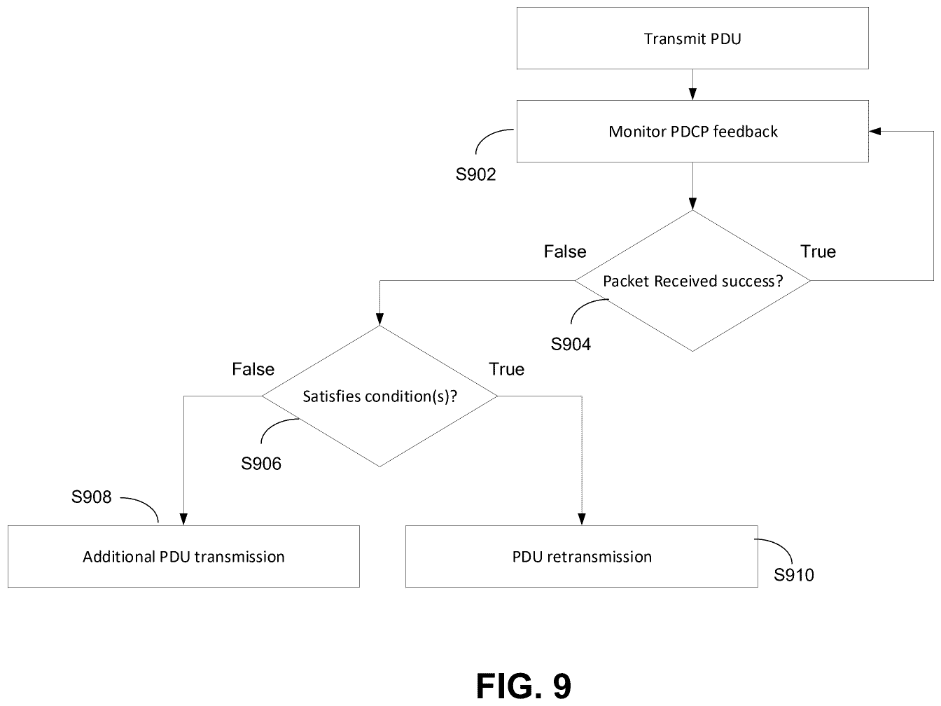

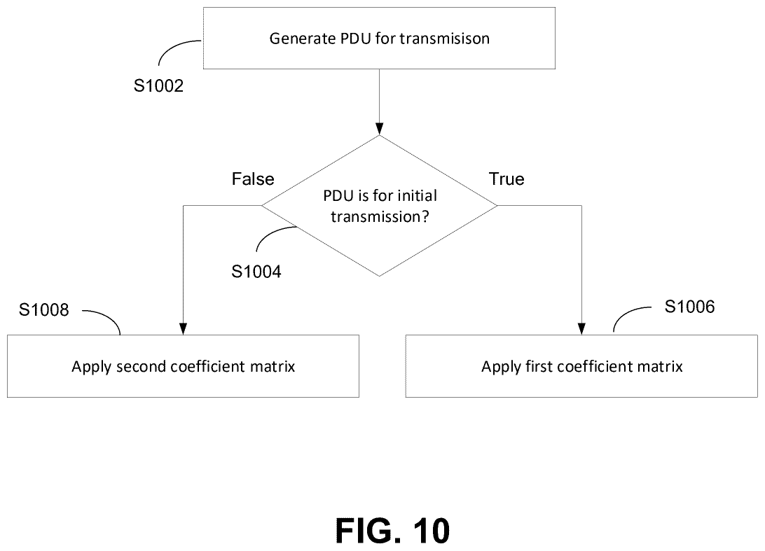

The present principles will now be described with the help of flowcharts in FIGS. 7-10, wherein FIG. 7 illustrates an overall method in a transmitting UE according to an embodiment of the present principles, FIG. 8 illustrates an overall method in a receiving UE according to an embodiment of the present principles, FIG. 9 illustrates a method of determination of retransmission and additional transmission according to an embodiment of the present principles, and FIG. 10 illustrates a method of coefficient matrix selection according to an embodiment of the present principles.

As already mentioned, in the provided examples, the NC protocol is performed after PDCP header addition but before routing PDCP PDU(s) to the lower layer. That is, for each PDCP SDU, the PDCP entity generates a PDCP header to be attached to the PDCP SDU before performing the NC encoding process. After the NC encoding process, the PDCP entity routes the output packet (i.e., PDCP PDU) to the lower layer. The PDCP header is also assumed to be encoded by the NC protocol.

After the NC protocol is implemented in the transmitting UE (i.e., in transmitting PDCP entity of the transmitting UE), the overall processing in the transmitting UE side may be described with reference to FIG. 7 that illustrates an implementation example.

In step S702, the transmitting UE receives NC configuration information from the gNB. The NC configuration may for example be carried by a downlink RRC message and it may be implemented as already described.

In step S704, the transmitting UE configures a NC protocol in the transmitting PDCP entity based on the received NC configuration information. The NC protocol may be either configured as a segmented-SDU based NC or a cross-SDUs based NC, both of which have already been described.

In step S706, the transmitting PDCP entity of the transmitting UE receives at least one SDU from the upper layer.

In step S708, the transmitting UE pre-processes the received SDU.

In case segmented-SDU based NC is configured, the transmitting UE segments each received SDU into multiple SDU segments based on the NC configuration. Specifically, the transmitting UE segments a received SDU into x SDU segments, wherein the x may be determined based on maximum_encoding_NC_segments (x is equal to or smaller than maximum_encoding_NC_segments), maximum_SDU_segment_size (the size of each of the x SDU segments is equal to or smaller than maximum_SDU_segment_size), maximum_SDU_segments (x is equal to or smaller than maximum_SDU_segments), and/or the number of coefficient vector in a coefficient matrix (x is equal to or smaller than the number of coefficient vectors in a coefficient matrix).

In case cross-SDUs based NC is configured, the transmitting UE groups multiple SDUs into a NC SDU set based on the NC configuration. Specifically, the transmitting UE groups x received SDUs into a NC SDU set, wherein the x may be determined based on maximum_number_SDU (x is equal to or smaller than maximum_number_SDU).

The pre-processing may for example be one or more of the procedures defined for legacy PDCP (e.g., ciphering, integrity protection, etc.).

In step S710, the transmitting UE sequences the SDUs or SDU segments.

In case segmented-SDU based NC is configured, the transmitting UE sequences each SDU segment. That is, the transmitting UE assigns a segment SN and a SDU SN to a SDU segment of a SDU based on an order (or position) of the SDU segment within the SDU.

In case cross-SDUs based NC is configured, the transmitting UE sequences each SDU. That is, the transmitting UE assigns a NC SDU set SN to each SDU of a NC SDU set based on an order of the SDU segment within the SDU.

In step S712, the transmitting UE performs NC encoding by using the SDU segment or SDU to generate one or more PDU(s).

In step S714, the transmitting UE sequences the PDUs. This is done by assigning/associating an order SN to a PDU based on a type of the PDU and based on an order of the PDU within a NC PDU set, a NC PDU set SN to each PDU based on an association of the PDU with a NC PDU set, and a PDU type indicator to each of the PDUs.

The transmitting UE may include the order SN, NC PDU set SN and/or PDU type indicator in either a sub-header of the PDU or a payload of the PDU.

In step S716, the transmitting UE delivers the PDU to the lower layer.

After the NC protocol is implemented in receiving UE (a.k.a. in receiving PDCP entity of the receiving UE), the overall processing in the receiving UE side may be described with reference to FIG. 8. As for FIG. 7, FIG. 8 illustrates an example implementation.

In step S802, the receiving UE receives NC configuration information from the gNB. The NC configuration may for example be carried by a downlink RRC message. The NC configuration may be implemented as already described.

The NC configuration may for example be a radio bearer/a PDCP specific configuration. That is, for different PDCP entities/radio bearers configured with NC protocol respectively, the gNB may provide individual NC configurations for each of the configured NC protocols.

In step S804, the receiving UE configures a NC protocol in its receiving PDCP entity based on the received NC configuration information. The NC protocol may be either configured as a segmented-SDU based NC or cross-SDUs based NC.

In step S806, the receiving PDCP entity of the receiving UE receives at least a PDU from the upper layer.

In step S808, the receiving UE pre-processes the received PDU.

The pre-processing can include one or more of the following.

Identification of the NC process the received PDU should be associated with based on the NC PDU set SN of the received PDU.

Identification of the coding coefficients applied by the transmitting UE to generate the PDU based on one or more of a coefficient matrix index carried by the PDU, a coefficient vector index carried by the PDU, and a coding coefficient(s) carried by the PDU.

Identification of the order of the received PDU within a NC PDU set based on at least the order SN of the received PDU, and the NC PDU set SN of the received PDU.

The pre-processing may for example be be one or more of the procedures defined for legacy PDCP.

In step S810, the receiving UE performs NC decoding by using the received PDU and the identified coding coefficients, which results in one or more recovered SDU(s) or SDU segments.

In step S812, in case segmented-SDU based NC is configured, the receiving UE reassembles the SDU segments to generate a SDU based on the segment SN of the SDU segment and the SDU SN. The segment SN and/or the SDU SN of a SDU segment may be carried by either the sub-header of the SDU segment or the payload of the SDU segment.

In step S814, the receiving UE delivers the SDU to the upper layer.

FIG. 9 illustrates a method of determination of retransmission and additional transmission according to an embodiment of the present principles. After a transmitting UE transmits a PDU to gNB, in step S902, it monitors PDCP feedback to determine, in step S904, whether the transmitted PDU has been received successfully or not. In case the transmitted PDU is not received by the receiver (“False”), in step S906, the transmitting UE determines based on whether at least one specific condition is satisfied, whether to perform the PDU retransmission or additional PDU transmission. The transmitting UE then either performs additional PDU transmission, in step S908, or PDU retransmission, in step S910.

There may be different embodiments regarding the PDCP feedback.

The PDCP feedback may be transmitted from the receiver to the transmitter. In case of downlink, the PDCP feedback is transmitted from the gNB to the UE.

The PDCP feedback may be carried by a legacy PDCP status report.

The PDCP feedback may be carried by individual PDCP signaling.

The PDCP feedback may include one or more of a first feedback indicator indicating the receiving status of a NC PDU set based on a NC PDU set SN, a second feedback indicator indicating the receiving status of a PDU based on a bitmap, and a third feedback indicator indicating the receiving status of a SDU based on legacy PDCP SN.

There may also be different embodiments regarding the specific condition mentioned for step S906. For example, the specific condition may be one or more of the first feedback indicator and/or the second feedback indicator indicating a missing PDU of a NC PDU set, the first feedback indicator and/or the second feedback indicator indicating that a NC PDU set has not been decoded successfully, and the third feedback indicator indicating that a SDU has not been received successfully.

In response to the transmitting UE's determination to generate additional PDU(s), the transmitting UE generates a specific amount of PDUs, wherein the specific amount is preconfigured by a NC configuration received from the gNB.

FIG. 10 illustrates coefficient matrix selection at a transmitting UE. After transmitting a PDU to gNB, the transmitting UE may monitor PDCP feedback to determine whether the transmitted PDU has been received successfully or not. In case the transmitted PDU is not successfully received, the transmitting UE may determine whether to perform the PDU retransmission (step S908 of FIG. 9) or additional PDU transmission (step S910 of FIG. 9). In other words, the PDU may be generated for initial transmission or for additional transmission.

In case the transmitting UE has determined to generate, in step S1002, a PDU for transmission, it may determine to apply either a first coefficient matrix, in step S1006, or a second coefficient matrix, in step S1008, based on a determination, in step S1004, whether the PDU is generated for initial transmission or for additional transmission.

In other embodiments, step S1006 includes applying first range of rows of a coefficient matrix and step S1008 includes applying second range of rows of the coefficient matrix.

While selecting coding coefficients, the transmitting UE may additionally consider the QoS characteristics of the corresponding radio bearer. For example, different SDUs may be associated with different data flows depending on their different characteristics. The transmitting UE may apply different coefficients matrices (range of rows of a coefficient matrix) to generate PDU(s) in case a different SDU is used.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency trade-offs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

What is claimed is:

1. A method at a wireless transmit/receive unit, WTRU, the method comprising:
obtaining a set of data units, the set comprising at least one data unit, each data unit being a service data unit, SDU, or a SDU segment;
performing network coding, NC, encoding on the set of data units to obtain a set of packet data units, PDUs;
assigning an order sequence number, SN, to each PDU, the order SN depending on a type of PDU and indicating an order of the PDU among PDUs of the same type in the set of PDUs and being respectively unique to the set of PDUs;
assigning a set SN to the set of PDUs, the set SN being common to the set of PDUs;
attaching a NC-specific sub-header to each PDU, the sub-header comprising at least one of the order SN and the set SN; and
sending the set of PDUs to a receiver.

2. The method of claim 1, further comprising:
selecting based on received NC configuration information, for each PDU, the order SN from a range specific to a type of the PDU, wherein the received NC configuration information indicates a plurality of ranges of order SN, each range being associated with a type of PDU.

3. The method of claim 2, wherein the configuration information is received from a base station.

4. The method of claim 2, wherein types of PDU include one or more of systematic packets, non-systematic packets, error correction packets, and erasure correction packets.

5. The method of claim 2, wherein the attaching further comprises including, in the sub-header of each PDU, information indicative of the type of the PDU.

6. The method of claim 1, wherein the set SN is based on a data unit SN associated with the set of data units.

7. The method of claim 6, wherein the set SN is equal to a data unit SN from a data unit in the set of data units, a smallest data unit SN from a data unit in the set of data units, or a largest data unit SN from a data unit in the set of data units.

8. The method of claim 1, wherein the set SN is a Packet Data Convergence Protocol, PDCP, SN of at least one data unit in the set of data units.

9. The method of claim 1, further comprising:
determining, using feedback from the receiver, whether at least one retransmission condition is fulfilled; and
in case the at least one retransmission condition is fulfilled, retransmitting at least one PDU of the set of PDUs,
wherein the at least one retransmission condition comprises one of a missing PDU in the received set of PDUs, unsuccessful decoding of a PDU in the received set of PDUs, unsuccessful decoding of data unit of the received set of PDUs, and a missing SDU in a corresponding received set of data units.

10. The method of claim 9, further comprising:
in case the at least one retransmission condition is not fulfilled, performing further NC encoding on the set of data units to obtain a further set of packet data units, PDUs, wherein the further NC encoding uses at least one of different coding coefficients, different coefficient vectors and a different coefficient matrix compared to the NC encoding used to obtain the set of PDUs; and
sending the further set of PDUs to the receiver.

11. A wireless transfer/receive unit, WTRU, comprising at least one processor configured to:
obtain a set of data units, the set comprising at least one data unit, each data unit being a service data unit, SDU, or a SDU segment;
perform network coding, NC, encoding on the set of data units to obtain a set of packet data units, PDUs;
assign an order sequence number, SN, to each PDU, the order SN indicating an order of the PDU in the set of PDUs and being respectively unique to the set of PDUs;
assign a set SN to the set of PDUs, the set SN being common to the set of PDUs;
attach a NC-specific sub-header to each PDU, the sub-header comprising at least one of the order SN and the set SN; and
send the set of PDUs to a receiver.

12. The WTRU of claim 11, wherein the at least one processor is further configured to:
select based on received NC configuration information, for each PDU, the order SN from a range specific to a type of the PDU, wherein the received NC configuration information indicates a plurality of ranges of order SN, each range being associated with a type of PDU.

13. The WTRU of claim 12, wherein the at least one processor is configured to receive the configuration information from a base station.

14. The WTRU of claim 12, wherein types of PDU include one or more of systematic packets, non-systematic packets, error correction packets, and erasure correction packets.

15. The WTRU of claim 12, wherein the at least one processor is further configured to include, in the sub-header of each PDU, information indicative of the type of the PDU.

16. The WTRU of claim 11, wherein the set SN is based on a data unit SN associated with the set of data units.

17. The WTRU of claim 16, wherein the set SN is equal to a data unit SN from a data unit in the set of data units, a smallest data unit SN from a data unit in the set of data units, or a largest data unit SN from a data unit in the set of data units.

18. The WTRU of claim 11, wherein the set SN is a Packet Data Convergence Protocol, PDCP, SN of at least one data unit in the set of data units.

19. The WTRU of claim 11, wherein the at least one processor is further configured to:
determine, using feedback from the receiver, whether at least one retransmission condition is fulfilled; and
in case the at least one retransmission condition is fulfilled, retransmit at least one PDU of the set of PDUs,
wherein the at least one retransmission condition comprises one of a missing PDU in the received set of PDUs, unsuccessful decoding of a PDU in the received set of PDUs, unsuccessful decoding of data unit of the received set of PDUs, and a missing SDU in a corresponding received set of data units.

20. The WTRU of claim 19, wherein the at least one processor is further configured to:
in case the at least one retransmission condition is not fulfilled, perform further NC encoding on the set of data units to obtain a further set of packet data units, PDUs, wherein the further NC encoding uses at least one of different coding coefficients, different coefficient vectors and a different coefficient matrix compared to the NC encoding used to obtain the set of PDUs; and
send the further set of PDUs to the receiver.
